(19) United States
(12) Patent Application Publication
(10) Pub. No.: US 2014/0062053 A1
(43) Pub. Date: Mar. 6, 2014

(54) REFLECTIVE MUD FLAP

(71) Applicant: William Joseph Cerveny, Glendale, AZ (US)

(72) Inventor: William Joseph Cerveny, Glendale, AZ (US)

(21) Appl. No.: 14/011,911

(22) Filed: Aug. 28, 2013

Related U.S. Application Data
(60) Provisional application No. 61/694,219, filed on Aug. 28, 2012.

(51) Int. Cl. B62D 25/18; B29C 69/00; G02B 5/12

(52) U.S. Cl. CPC B62D 25/188; G02B 5/12; B29C 69/00
USPC 280/154; 280/847; 264/154

(57) ABSTRACT

A reflective mud flap is disclosed. The reflective mud flap includes a front facing covered with reflective material and a rear facing covered with reflective material. A planar attachment tab extends from a top portion of the reflective mud flap, the planar attachment tab includes a pair of attachment apertures disposed on a top portion of the planar attachment tab. The pair of attachment apertures accommodate a pair of fasteners to couple the reflective mud flap to a vehicle. A process for the manufacture of a reflective mud flap includes obtaining a base mud flap, molding a plurality of reflective material into the base mud flap and producing a plurality of attachment apertures disposed on the base mud flap.

This application claims priority to U.S. Provisional Application 61/694,219 filed on Aug. 28, 2012, the entire disclosure of which is incorporated by reference.

### BACKGROUND OF THE INVENTION

1. Field of the Invention

The present invention is a mud flap. More specifically, the present invention is a reflective mud flap.

2. Description Of The Related Art

Safety is always a top priority with driving on today's roads, especially on today's modern highways. Mud flaps increase the safety of relatively larger vehicles such as tractor trailer trucks.

### BRIEF SUMMARY OF THE INVENTION

The present invention is a mud flap. More specifically, the present invention is a reflective mud flap.

The reflective mud flap includes a front facing covered with reflective material, a rear facing covered with reflective material and a planar attachment tab extended from a top portion of the reflective mud flap, the planar attachment tab includes a pair of attachment apertures disposed on a top portion of the planar attachment tab and the pair of attachment apertures accommodate a pair of fasteners to couple the reflective mud flap to a vehicle. The reflective mud flap complies with one or more DOT regulations and is made of rubber.

It is an object of the present invention to provide a reflective mud flap that complies with one or more DOT regulations and is designed as a safety device.

It is an object of the present invention to provide a reflective mud flap that has a planar shape and surface that is entirely covered with reflective material to increase vehicle visibility from a rear portion of a vehicle.

It is an object of the present invention to provide a reflective mud flap that has a planar attachment tab that allows the reflective mud flap to be easily coupled to a vehicle and increase vehicle visibility from a rear portion of the vehicle.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a front environmental view of a reflective mud flap, in accordance with one embodiment of the present invention.

FIG. 2 illustrates a side environmental view of a reflective mud flap, in accordance with one embodiment of the present invention.

FIG. 3 illustrates a front view of a reflective mud flap, in accordance with one embodiment of the present invention.

FIG. 4 illustrates a flowchart of a process for the manufacture of a reflective mud flap, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

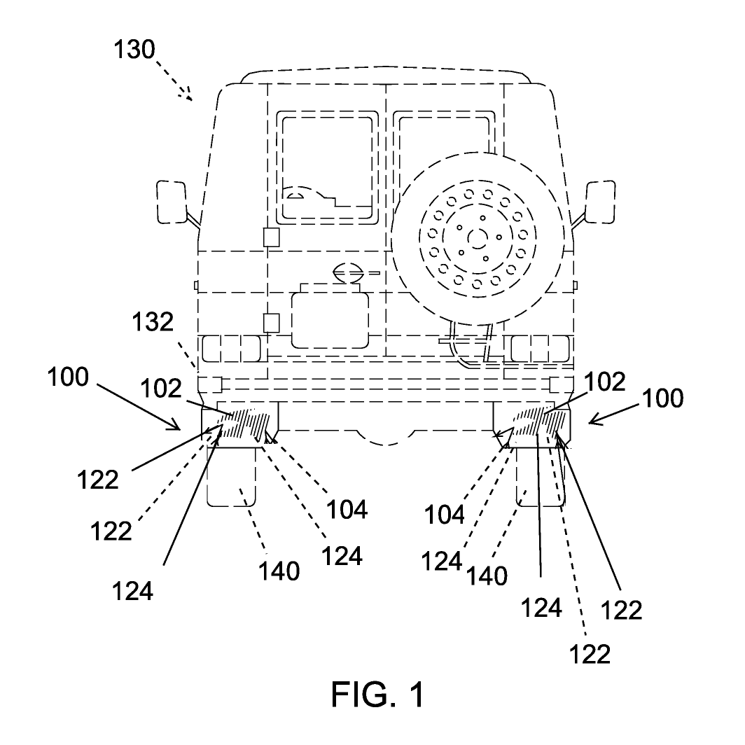

FIG. 1 illustrates a front environmental view of a reflective mud flap 100, in accordance with one embodiment of the present invention. The reflective mud flap 100 illustrated in FIG. 1 is coupled to a sports utility vehicle or SUV 110.

The reflective mud flap 100 may have a front facing 102 and a rear facing 104. The front facing 102 may be entirely covered with reflective material 120 such as reflective paint 122, reflective tape 124 or other suitable reflective material. The back facing 104 may be entirely covered with reflective material 120 such as reflective paint 122, reflective tape 124 or other suitable reflective material. The reflective mud flap 100 may be coupled to a rear portion 132 of a vehicle 130 such as a personal vehicle such as a pick-up truck (not shown), a van (not shown), and a commercial vehicle (not shown) such as a tractor trailer (not shown) or other suitable vehicle. More specifically, the reflective mud flap 100 may be disposed behind each of a pair of rear tires 140. The reflective mud flap 100 may assist in preventing mud or other debris from flying off the pair of rear tires 140 from the rear portion 132 of the vehicle 130. The reflective mud flap 100 may be made of durable rubber or other suitable durable material. The reflective mud flap 100 may comply with one or more DOT regulations and may be designed as a safety device.

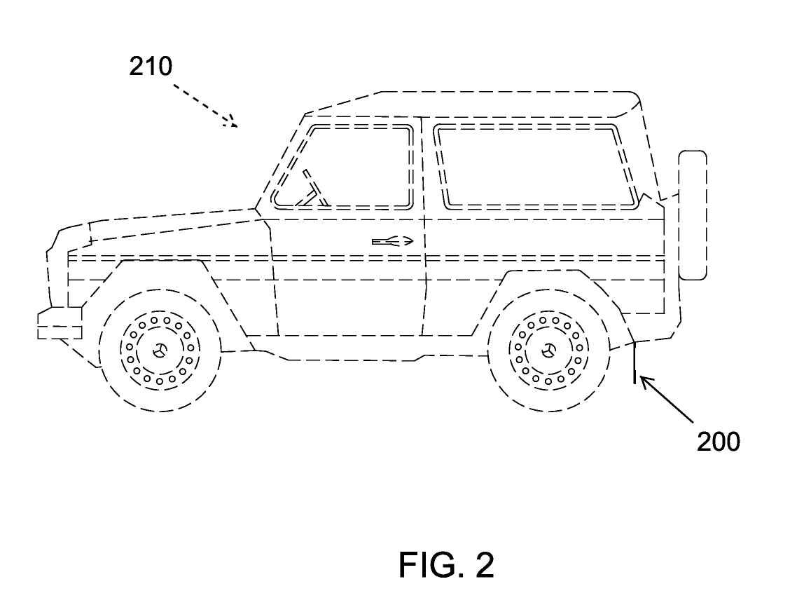

FIG. 2 illustrates a side environmental view of a reflective mud flap 200, in accordance with one embodiment of the present invention. The reflective mud flap 200 illustrated in FIG. 2 is coupled to a SUV 210.

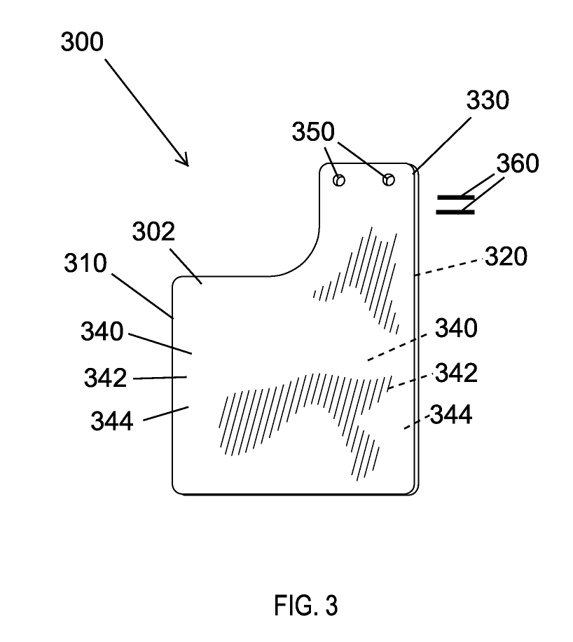

FIG. 3 illustrates a front view of a reflective mud flap 300, in accordance with one embodiment of the present invention.

The reflective mud flap 300 may have a front facing 310, a rear facing 320 and a planar attachment tab 330. The front facing 310 may be entirely covered with reflective material 340 such as reflective paint 342, reflective tape 344 or other suitable reflective material. The back facing 320 may be entirely covered with reflective material 340 such as reflective paint 342, reflective tape 344 or other suitable reflective material. The planar attachment tab 330 may extend from a top portion 302 of the reflective mud flap 300. The planar attachment tab 330 may include a pair of attachment apertures 350 disposed on a top portion 332 of the planar attachment tab 330. The pair of attachment apertures 350 may accommodate a pair of fasteners 360 to couple the reflective mud flap 300 to a vehicle (FIG. 1,130). The pair of attachment apertures 350 may include any suitable number of attachment apertures such as three apertures, four apertures or more. The pair of fasteners 360 may include any suitable type of fastener such as a screw, a bolt or a rivet. The reflective mud flap 300 may be made of durable rubber or other suitable durable material. The reflective mud flap 300 may comply with one or more DOT regulations and may be designed as a safety device.

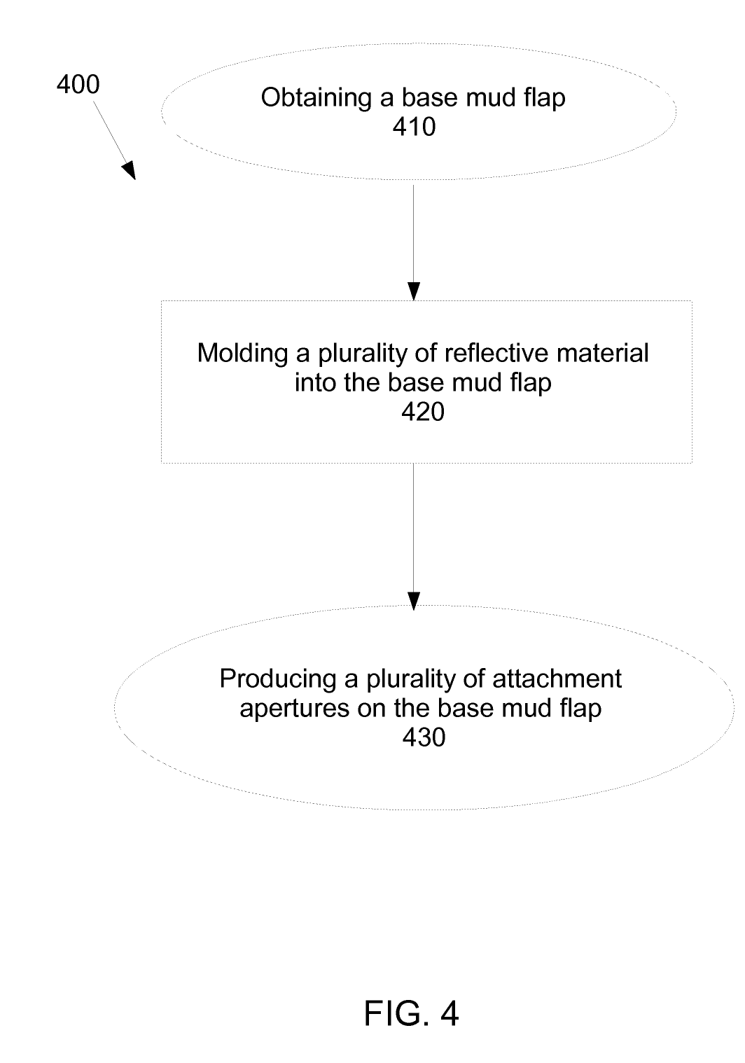

FIG. 4 illustrates a flowchart of a process for the manufacture of a reflective mud flap, in accordance with one embodiment of the present invention.

The process for the manufacture of a reflective mud flap 400 includes the steps of obtaining a base mud flap 410, molding a plurality of reflective material into the base mud flap 420 and producing a plurality of attachment apertures on the base mud flap 430. The obtaining step may include a base mud flap having a planar attachment tab. The molding step may include the base mud flap may be may have a front facing, a rear facing or be entirely covered with reflective material. The reflective material may be reflective paint, reflective tape or other suitable reflective material. The producing step may include the attachment apertures may be produced on the planar attachment tab.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

What is claimed is:

1. A reflective mud flap, comprising:
a front facing covered with reflective material;
a rear facing covered with the reflective material; and
a planar attachment tab extended from a top portion of the reflective mud flap, the planar attachment tab includes a pair of attachment apertures disposed on a top portion of the planar attachment tab.

2. The reflective mud flap according to claim 1, wherein the reflective material is reflective paint.

3. The reflective mud flap according to claim 1, wherein the reflective material is reflective tape.

4. The reflective mud flap according to claim 1, wherein the pair of attachment apertures accommodate a pair of fasteners.

5. The reflective mud flap according to claim 4, wherein the pair of fasteners couple the reflective mud flap to a vehicle.

6. The reflective mud flap according to claim 1, wherein the reflective mud flap is coupled to a rear portion of the vehicle.

7. The reflective mud flap according to claim 1, wherein the reflective mud flap is disposed behind a pair of rear tires.

8. The reflective mud flap according to claim 1, wherein the reflective mud flap assists in preventing mud from flying off the pair of rear tires.

9. The reflective mud flap according to claim 1, wherein the reflective mud flap assists in preventing debris from flying off the pair of rear tires.

10. The reflective mud flap according to claim 1, wherein the reflective mud flap complies with one or more DOT regulations.

11. The reflective mud flap according to claim 1, wherein the reflective mud flap is made of rubber.

12. The reflective mud flap according to claim 1, wherein the reflective mud flap is coupled to a sports utility vehicle.

13. A process for the manufacture of a reflective mud flap which comprises:
obtaining a base mud flap;
molding a plurality of reflective material into the base mud flap; and
producing a plurality of attachment apertures disposed on the base mud flap.

14. The process according to claim 13, wherein the obtaining step includes the base mud flap having a planar attachment tab.

15. The process according to claim 13, wherein the molding step includes the base mud flap has a front facing entirely covered with the reflective material.

16. The process according to claim 13, wherein the molding step includes the base mud flap has a rear facing entirely covered with the reflective material.

17. The process according to claim 13, wherein the molding step includes the entire base mud flap covered with the reflective material.

18. The process according to claim 13, wherein the reflective material is reflective paint.

19. The process according to claim 13, wherein the reflective material is reflective tape.

20. A reflective mud flap manufactured by the process according to claim 13.
